(19) United States
(12) Patent Application Publication
(10) Pub. No.: US 2026/0235892 A1
(43) Pub. Date: Aug. 13, 2026

(54) SMART GLASSES

(71) Applicant: LG ELECTRONICS INC., Seoul (KR)

(72) Inventors: Hyukjae LEE, Seoul (KR); Kanghee MIN, Seoul (KR); Youngdo CHA, Seoul (KR); Chalkee JUNG, Seoul (KR); Minsoo KIM, Seoul (KR); Sungkwon JANG, Seoul (KR)

(73) Assignee: LG ELECTRONICS INC., Seoul (KR)

(21) Appl. No.: 19/182,156

(22) Filed: Apr. 17, 2025

(30) Foreign Application Priority Data
Jan. 7, 2025 (WO) PCT/KR2025/000278

(51) Int. Cl. G02C 11/00; G02C 5/14

(52) U.S. Cl. CPC G02C 11/10; G02C 5/14

(57) ABSTRACT

Smart glasses include: a lens frame coupled to a pair of lenses; and a pair of temple frames configured to be hinge-coupled to the lens frame. The temple frames include: an outer cover configured to form an inner space; an inner cover coupled to the outer cover and including a contact portion that contacts a user's skin; and a speaker module disposed in the inner space. The speaker module includes: a first housing forming a first accommodation space connected to the inner space; a second housing accommodated in the first housing and forming a second accommodation space; and a diaphragm disposed at one surface of the second housing. The first accommodation space and the inner space form a first resonance space in which a first sound generated by vibration of the diaphragm resonates. The second accommodation space forms a second resonance space in which a second sound generated by vibration of the diaphragm resonates.

### CROSS-REFERENCE TO RELATED APPLICATION(S)

Pursuant to 35 U.S.C. § 119, this application claims the benefit of earlier filing date and right of priority to International Application No. PCT/KR2025/000278, filed on Jan. 7, 2025, the contents of which are all incorporated by reference herein in their entirety.

### BACKGROUND OF THE DISCLOSURE

### Field Of The Disclosure

Embodiments of the present disclosure relate to Smart glasses, and more particularly to Smart glasses in which the movement paths of first and second sounds generated by a speaker module are separated from each other.

### Discussion of the Related Art

Augmented reality (AR) is technology that superimposes virtual objects on the real world viewed by a user. As augmented reality (AR) shows a combination of actual reality and virtual reality having additional information in real time through one image, augmented reality (AR) is also called mixed reality (MR). A hybrid virtual reality (VR) system that combines the real environment and the virtual environment has been studied and developed with the United States as a leader since the late 1990s.

Augmented reality (AR), which is a concept that supplements the real world with the virtual world, uses a virtual environment created with computer graphics, but the main role of augmented reality (AR) is the real environment. Computer graphics serve to provide additional information necessary for the real environment. This means that distinction between the real environment and the virtual screen becomes ambiguous by superimposing a three-dimensional (3D) virtual image with the real image being viewed by the user's eyes.

Augmented reality (AR) technology, which mixes the real environment and virtual object(s), allows the user to view an image of the real environment, thereby providing a better sense of reality and additional information. For example, if the user points his or her smartphone camera at the surroundings, information such as the location and phone number of nearby stores, and other information are displayed in three-dimensional (3D) images.

Augmented reality (AR) may be used in remote medical diagnosis, broadcasting, architectural design, manufacturing process management, etc. In addition, as smartphones have become widely popularized, they have entered the full-scale commercialization stage, and various products are being developed in the game and mobile solution industries and education fields.

As one way to realize augmented reality (AR), the user may wear Smart glasses. Smart glasses usually include technological components such as small electronic components, sensors, and displays. In particular, Smart glasses include a speaker module therein to provide sound to the user.

### SUMMARY OF THE DISCLOSURE

Accordingly, the present disclosure is directed to Smart glasses that substantially obviate one or more problems due to limitations and disadvantages of the related art.

An object of the present disclosure is to provide Smart glasses including a speaker module designed to separate resonance spaces of first sound and second sound from each other.

Technical tasks obtainable from the present disclosure are non-limited by the above-mentioned technical tasks. And, other unmentioned technical tasks can be clearly understood from the following description by those having ordinary skill in the technical field to which the present disclosure pertains.

Additional advantages, objects, and features of the disclosure will be set forth in the disclosure herein as well as the accompanying drawings. Such aspects may also be appreciated by those skilled in the art based on the disclosure herein.

To achieve these objects and other advantages and in accordance with the purpose of the invention, as embodied and broadly described herein, the Smart glasses may include: a lens frame coupled to a pair of lenses; and a pair of temple frames configured to be hinge-coupled to the lens frame. The temple frames include: an outer cover configured to form an inner space; an inner cover coupled to the outer cover and including a contact portion that contacts a user's skin; and a speaker module disposed in the inner space. The speaker module includes: a first housing forming a first accommodation space connected to the inner space; a second housing accommodated in the first housing and forming a second accommodation space; and a diaphragm disposed at one surface of the second housing. The first accommodation space and the inner space form a first resonance space in which a first sound generated by vibration of the diaphragm resonates. The second accommodation space forms a second resonance space in which a second sound generated by vibration of the diaphragm resonates.

The outer cover may include: a first sound hole formed at an upper portion of the outer cover; and a second sound hole formed at a lower portion of the outer cover, wherein the first sound is emitted to the outside through the first sound hole, and the second sound is emitted to the outside through the second sound hole.

A movement path of the first sound to the first sound hole is formed longer than a movement path of the second sound to the second sound hole.

The outer cover may include: a prevention member configured to prevent moisture from entering the temple frame through the first sound hole or the second sound hole.

The diaphragm may be arranged such that a rear surface of the diaphragm is located in the first accommodation space and a front surface of the diaphragm is located in the second accommodation space.

The first accommodation space may be formed by the rear surface of the diaphragm; and the second accommodation space may be formed by the front surface of the diaphragm.

The diaphragm may include: a convex portion formed convexly from the front surface of the diaphragm.

The first sound may correspond to a sound generated from the rear surface of the diaphragm; and the second sound may correspond to a sound generated from the front surface of the diaphragm.

The first resonance space may be formed to have a larger size than the second resonance space.

The first resonance space may be formed not to overlap the second resonance space.

The first accommodation space may be formed separately from the second accommodation space.

The first housing may include a through-hole formed on one surface; and the first sound may move from the first accommodation space to the internal space through the through-hole.

The above-described solutions of the present disclosure are only some of the preferred embodiments of the present disclosure, and various embodiments reflecting the technical features of the present disclosure may be derived and understood from the following detailed description of the present disclosure by those skilled in the art.

It is to be understood that both the foregoing general description and the following detailed description of the present disclosure are exemplary and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure.

FIG. 1 is a diagram illustrating Smart glasses according to the embodiments of the present disclosure.

FIG. 2 is an exploded view illustrating a temple frame of Smart glasses according to the embodiments of the present disclosure.

FIG. 3 is a diagram illustrating a speaker module of Smart glasses according to the embodiments of the present disclosure.

FIGS. 4 to 6 are views illustrating example cross-sections of a temple frame of Smart glasses according to the embodiments of the present disclosure.

FIGS. 7 and 8 are views illustrating sound paths generated by speaker modules of Smart glasses according to the embodiments of the present disclosure.

### DETAILED DESCRIPTION OF THE DISCLOSURE

Description will now be given in detail according to exemplary embodiments disclosed herein, with reference to the accompanying drawings. The same or equivalent components may be provided with the same reference numbers, and description thereof will not be repeated. As used herein, the suffixes “module” and “part” are added or used interchangeably to facilitate preparation of this specification and are not intended to suggest distinct meanings or functions. In describing embodiments disclosed in this specification, relevant well-known technologies may not be described in detail in order not to obscure the subject matter of the embodiments disclosed in this specification. In addition, it should be noted that the accompanying drawings are only for easy understanding of the embodiments disclosed in the present specification, and should not be construed as limiting the technical spirit disclosed in the present specification. As such, the present disclosure should be construed to extend to any alterations, equivalents and substitutes in addition to those which are particularly set out in the accompanying drawings.

Although the terms first, second, etc. may be used herein to describe various elements, these elements should not be limited by these terms. These terms are generally only used to distinguish one element from another.

It will be understood that when an element is referred to as being “connected with” another element, the element can be directly connected with the other element or intervening elements may also be present. In contrast, it will be understood that when an element is referred to as being “directly connected with” another element, there are no intervening elements present.

A singular representation may include a plural representation unless it represents a definitely different meaning from the context.

The terms such as “include” or “have” used herein are intended to indicate that features, numbers, steps, operations, elements, components, or combinations thereof used in the following description exist and it should be thus understood that the possibility of existence or addition of one or more different features, numbers, steps, operations, elements, components, or combinations thereof is not excluded.

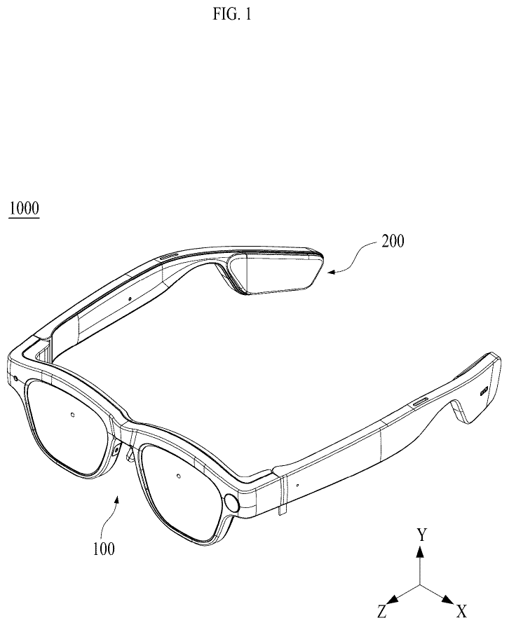

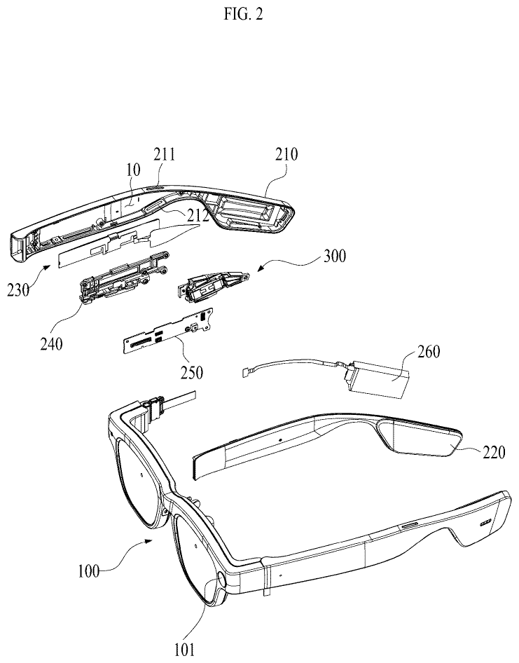

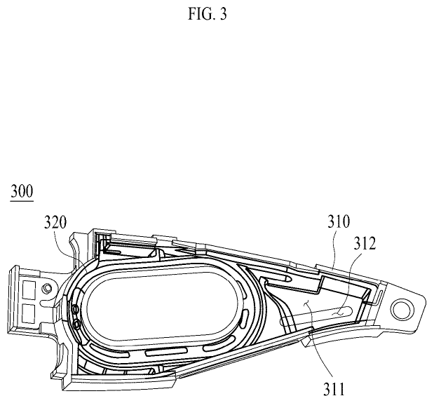

FIG. 1 is a diagram illustrating Smart glasses 1000 according to the embodiments of the present disclosure. FIG. 2 is an exploded view illustrating a temple frame 200 of the Smart glasses 1000 according to the embodiments of the present disclosure. FIG. 3 is a diagram illustrating a speaker module 300 of the Smart glasses 1000 according to the embodiments of the present disclosure.

Hereinafter, in describing the smart glasses 1000 according to the embodiments of the present disclosure, the left and right directions will hereinafter be described based on an X-axis direction, the upper and lower directions will hereinafter be described based on a Y-axis direction, and the forward and backward directions will hereinafter be described based on a Z-axis direction.

Referring to FIG. 1 and FIG. 2, the Smart glasses 1000 according to the embodiments may include a lens frame 100 and a temple frame 200.

The Smart glasses 1000 are glasses incorporated with digital technology and may correspond to a wearable device designed to allow the user to check and interact with various information in real time. The Smart glasses 1000 may provide the user with an experience that combines reality and digital information through augmented reality (AR) technology. For example, the Smart glasses 1000 may project a digital screen (such as a hologram or graphic, etc.) onto a lens coupled to a lens frame 100 to superimpose virtual information on the real world. Alternatively, for example, the Smart glasses 1000 may scan the user's surroundings with a mounted camera or sensor to create a 3D model or may recognize specific objects to provide information.

The lens frame 100 may be located at a position corresponding to the user's eyes while the user is wearing the Smart glasses on his/her body. The lens frame 100 may be combined with a pair of lenses, and the lenses may be located at a position covering the user's eyes while the user is wearing the Smart glasses. More specifically, the lens may be configured to display an image, and display the image in a manner in which the images of both eyes are combined and recognized by the user who is wearing the Smart glasses 1000, and may correspond to a type of optical module.

The lens frame 100 may be equipped with a camera mounted therein, and the camera lens 101 of the mounted camera may be exposed to the outside of the lens frame 100. That is, the camera mounted inside the Smart glasses 1000 may provide an image through the camera lens 101 exposed to the outside of the lens frame 100. As shown in FIGS. 1 and 2, only one camera lens 101 may be used, or, unlike as shown in FIGS. 1 and 2, two camera lenses 101 may be used. When two camera lenses 101 are used the two camera lenses 101 may be placed at both sides of a pair of lenses.

The temple frame 200 may be hinge-coupled to the lens frame 100. The temple frame 200 may rotate with respect to the lens frame 100. For example, the temple frame 200 may rotate clockwise or counterclockwise with respect to the Y-axis. The temple frame 200 may be implemented as one pair of temple frames.

The temple frame 200 may include an outer cover 210 forming an outer appearance of the temple frame 200, and an inner cover 220. More specifically, the outer cover 210 may form an outer appearance of the temple frame, and the inner cover 220 may be coupled to the outer cover 210 and may form an inner appearance of the temple frame. The inner cover 220 may include a contact portion that contacts the user's skin.

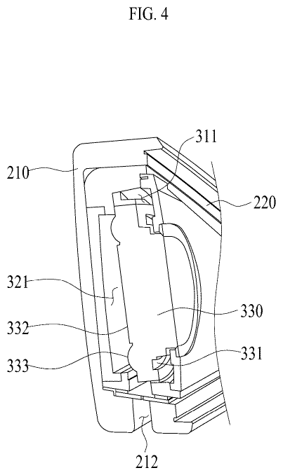

The outer cover 210 may include a first sound hole 211 formed at an upper portion of the Smart glasses, and a second sound hole 212 formed at a lower portion of the Smart glasses. A detailed description of the first sound hole 211 and the second sound hole 212 will be described with reference to FIGS. 4 to 6.

The outer cover 210 may form an internal space 10. The inner cover 220 may be coupled to the outer cover 210, so that the internal space 10 may be formed as a sealed space. Alternatively, both outer cover 210 and the inner cover 220 may form the internal space 10, or the inner cover 220 may form the internal space 10, and the outer cover 210 may be coupled to the inner cover 210, so that the internal space 10 may be formed as a sealed space.

Electronic components, etc., may be placed in the internal space 10. As shown in FIG. 2, a sensor unit 230, a bracket 240, a printed circuit board (PCB) 250, a battery 260, a speaker module 300, etc. may be placed in the internal space 10. The PCB 250 may be a concept that includes not only the PCB but also other hardware for driving the PCB.

The sensor unit 230 may correspond to a touch sensor that senses the user's touch or a detection sensor that detects the user's presence. Alternatively, the sensor unit 230 may correspond to both a touch sensor and a detection sensor. The touch sensor may be attached and placed on the outer surface from among the internal components of the temple frame 200, and the detection sensor may be attached and placed on the inner surface from among the internal components of the temple frame 200. That is, the touch sensor may be placed farthest from the user's face, and the detection sensor may be placed closest to the user's face.

The battery 260 may be placed at the rearmost side of the inside of the temple frame 200. That is, the battery 260 may be placed at the farthest position from the lens frame 100, and for example, the battery 260 may be placed behind the user's ear when the user wears the Smart glasses.

The speaker module 300 is a module that outputs sound and may be placed near the user's ear. That is, the speaker module 300 may be attached and placed on the inner surface from among the inside of the temple frame 200 to provide sound to the user and, in particular, may be placed close to the user's ears.

Referring to FIG. 3, the speaker module 300 may include a first housing 310, a second housing 320, and a diaphragm 330.

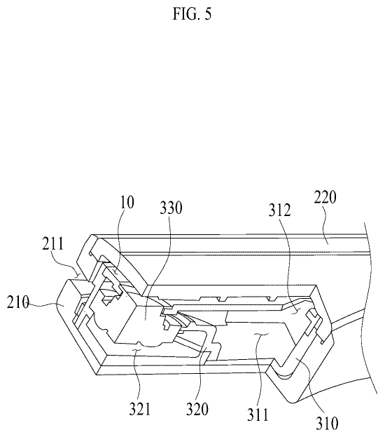

The first housing 310 may form a first accommodation space 311 connected to the internal space 10, and the second housing 320 may be accommodated in the first housing 310 and may form a second accommodation space 321(see FIGS. 4 and 5). That is, the internal space of the first housing 310 may include the second housing 320 and the first accommodation space 311.

The first housing 310 may include a through-hole 312 formed at one side thereof. The through-hole 312 will be described in detail with reference to FIGS. 4 to 6.

The diaphragm 330 may be located at one side of the second housing 320, and sound may be generated from one side and the other side of the diaphragm 330 due to vibration of the diaphragm 330. More specifically, the diaphragm 330 may be arranged at the upper side of the second housing 320, and sound may be generated from the front and rear surfaces of the diaphragm 330 due to forward and backward movement of the diaphragm 330.

In general, a speaker may generate sound by causing the diaphragm to vibrate in the forward and backward directions by electrical signals received from the outside. More specifically, sound waves may be generated by compressing or expanding the air according to the movement of the diaphragm. For example, when the diaphragm moves forward, the air on the front side of the diaphragm may be compressed to generate positive(+) phase sound waves, and the air on the rear side of the diaphragm may be expanded to generate negative(−) phase sound waves. Alternatively, for example, when the diaphragm moves backward, the air on the front side of the diaphragm may be expanded to generate positive(−) phase sound waves, and the air on the rear side of the diaphragm may be compressed to generate negative(−) phase sound waves.

The sound that the user hears may generally correspond to sound that occurs in front of the diaphragm. In other words, the speaker may generate sound by compressing(+) or expanding(−) the air in front of the diaphragm, and the generated sound may be emitted toward the user and may correspond to the sound that the user hears.

However, there is a problem that the (+) phase sound or (−) phase sound generated in the front of the diaphragm may be mixed with the (−) phase sound or (+) phase sound generated in the rear of the diaphragm, and may offset from each other, which can cause phase cancellation. In other words, for example, when the (+) phase sound is generated in front of the diaphragm, the (−) phase sound may be generated in the rear of the diaphragm, and when the sound generated in front and the sound generated in the rear are mixed, phase cancellation may occur, so that sound may be weakened or may disappear. Alternatively, when (−) phase sound is generated in front of the diaphragm, the (+) phase sound may be generated in the rear of the diaphragm, and when the sound generated in front and the sound generated in the rear are mixed, phase cancellation may also occur in a similar way to the described example, so that sound may be weakened or may disappear.

Therefore, it is necessary to separate the path of the sound generated from the front of the diaphragm from the path of the sound generated from the rear of the diaphragm, and it is also necessary to emit the sound generated from the rear to the outside rather than to the user.

Therefore, the speaker module 300 of the Smart glasses 1000 according to the embodiments may separately form a space where the sound generated from the front of the diaphragm 330 moves or resonates and another space where the sound generated from the rear of the diaphragm 330 moves or resonates.

Hereinafter, the speaker module 300 arranged inside the Smart glasses 1000 according to the embodiments will be described in detail.

FIGS. 4 to 6 are views illustrating example cross-sections of the temple frame 200 of the Smart glasses 1000 according to the embodiments of the present disclosure. More specifically, FIGS. 4 to 6 are cross-sectional views illustrating the speaker module 300 arranged inside the temple frame 200.

As shown in FIG. 3, the speaker module 300 may include a first housing 310, a second housing 320, and a diaphragm 330.

Referring to FIGS. 4 and 5, the first housing 310 may form a first accommodation space 311 connected to the internal space 10, and the second housing 320 may form a second accommodation space 321 not connected to the internal space 10. That is, the first accommodation space 311 and the second accommodation space 321 may be formed to be spatially separated from each other.

By the diaphragm 330 arranged at one surface of the second housing 320, one surface of the diaphragm 330 may be exposed to the outside of the second housing 320, and the other surface of the diaphragm 330 may not be exposed to the outside of the second housing 320. More specifically, the rear surface 331 of the diaphragm 330 may be located in the first accommodation space 311, and the front side (332) of the diaphragm 330 may be located in the second accommodation space 321.

First sound may be generated at the rear surface 331 by vibration (or movement) of the diaphragm 330. That is, the first sound may be generated by the air in the first accommodation space 311 being compressed or expanded by the vibration (or movement) of the diaphragm 330. For example, when the diaphragm 330 moves in the forward direction, the air in the first accommodation space 311 located at the rear surface 331 may be expanded, resulting in occurrence of negative(−) phase sound. Alternatively, for example, when the diaphragm 330 moves in the backward direction, the air in the first accommodation space 311 located at the rear surface 331 may be compressed, resulting in occurrence of positive(+) phase sound. That is, the first sound is a sound generated at the rear surface 331 by the vibration (or movement) of the diaphragm 330, and may include both the negative(−) phase sound and the positive(+) phase sound.

The first sound may move from the first accommodation space 311 to the internal space 10. More specifically, the first sound may move from the first accommodation space 311 to the internal space 10 through the through-hole 312 formed in the first housing 310. That is, the first accommodation space 311 and the internal space 10 may communicate with each other through the through-hole 312.

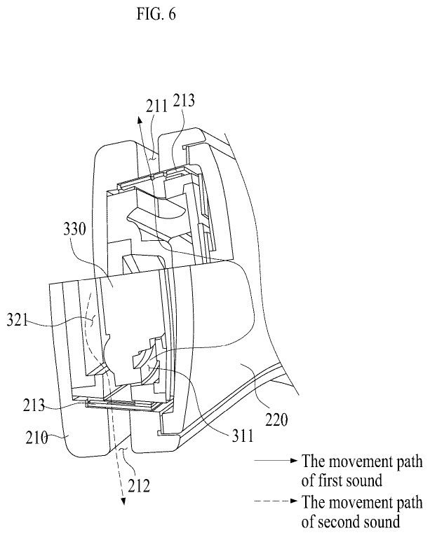

Referring to FIG. 6, the first sound generated from the rear surface 331 of the diaphragm 330 may move to the outside through the first sound hole 211 formed in the outer cover 210 from the first accommodation space 311. More specifically, referring to FIG. 4 together, the first sound may move from the first accommodation space 311 to the inner space 10 and may move to the outside through the first sound hole 211 from the inner space 10. The first sound hole 211 may be formed at the upper portion of the outer cover 210.

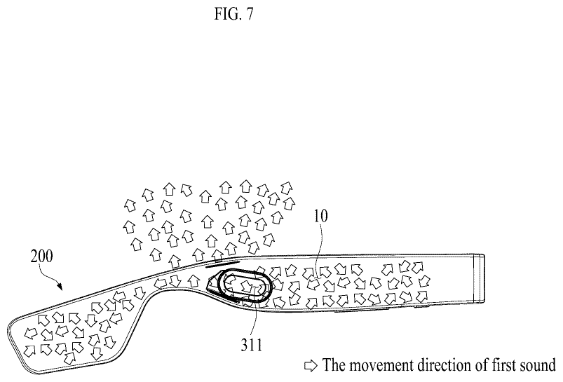

That is, the first sound may resonate in the first accommodation space 311 formed by the first housing 310 and may also resonate in the inner space 10 formed by the outer cover 210. That is, the first resonance space in which the first sound resonates may correspond to the first accommodation space 311 and the inner space 10. The first resonance space will be described in detail with reference to FIG. 7.

Alternatively, the second sound may be generated at the front surface 332 by the vibration (or movement) of the diaphragm 330. That is, the second sound may be generated by compressing or expanding the air in the second accommodation space 321 by the vibration (or movement) of the diaphragm 330. For example, when the diaphragm 330 moves in the front direction, the air in the second accommodation space 321 located at the front surface 332 may be compressed, resulting in occurrence of positive(+) phase sound. Alternatively, for example, when the diaphragm 330 moves in the backward direction, the air in the second accommodation space 321 located at the front surface 332 may be expanded, resulting in occurrence of negative(−) phase sound. That is, the second sound is a sound generated at the front surface 332 by the vibration (or movement) of the diaphragm 330, and may include both positive (+) phase sound and negative(−) phase sound.

The diaphragm 330 may include a convex portion 333 formed convexly from the front surface 332. In other words, the front surface 332 of the diaphragm 330 may have a convex portion 333 formed convexly, unlike the rear surface 331 which is formed flat. As illustrated in FIG. 5, the convex portion 333 may be formed around the front surface 332. That is, the convex portion 333 may be formed on the edge (border) forming the front surface 332.

The first sound may move from the first accommodation space 311 to the internal space 10. More specifically, the first sound may move from the first accommodation space 311 to the internal space 10 through the through-hole 312 formed in the first housing 310. That is, the first accommodation space 311 and the internal space 10 may communicate with each other via the through-hole 312.

Referring to FIG. 6, the second sound generated from the front surface 332 of the diaphragm 330 may move to the outside through the second sound hole 212 formed in the outer cover 210 in the second accommodation space 321. Unlike the first sound, the second sound may directly move from the second accommodation space 321 to the outside through the second sound hole 212. The second sound hole 212 may be formed at the bottom of the outer cover 210.

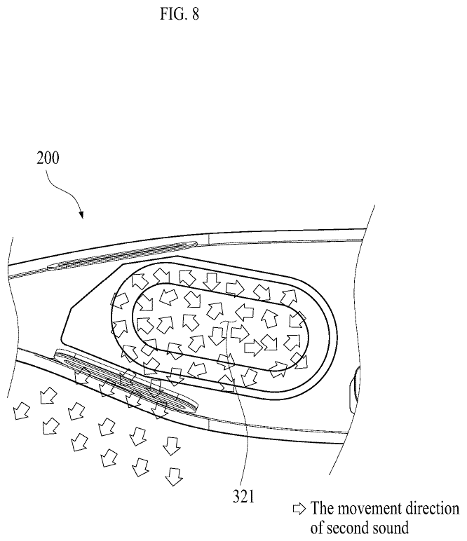

That is, the first sound may resonate only in the second accommodation space 321 formed by the second housing 320. That is, the second resonance space in which the second sound resonates may correspond to the second accommodation space 321. The second resonance space will be described in detail with reference to FIG. 8.

As illustrated in FIG. 6, the path along which the first sound is generated in the first accommodation space 311 until the first sound is discharged through the first sound hole 211 may be formed longer than the path along which the second sound is generated in the second accommodation space 321 until the second sound is discharged through the second sound hole 212. That is, the through-hole 312 connecting the first accommodation space 311 and the internal space 10 may be formed at a position far from the first sound hole 211.

The outer cover 210 may include a prevention member 213 to prevent moisture from entering through the first sound hole 211 or the second sound hole 212. That is, the prevention member 213 may prevent moisture from entering through the first sound hole 211 or the second sound hole 212.

FIGS. 7 and 8 are views illustrating sound paths generated by the speaker modules 300 of the Smart glasses 1000 according to the embodiments of the present disclosure. More specifically, FIG. 7 shows the path of the first sound generated by the speaker module 300, and FIG. 8 shows the path of the second sound generated by the speaker module 300.

Referring to FIG. 7, the first sound generated by the speaker module 300 may move or resonate in the first accommodation space 311 and the internal space 10, and may be discharged to the outside through the first sound hole 211 as described in FIGS. 4 to 6. More specifically, the first sound generated from the rear surface 331 of the diaphragm 330 may move or resonate in the first accommodation space 311 and the internal space 10, and may be discharged to the outside through the first sound hole 211 as described in FIGS. 4 to 6.

The first accommodation space 311 is a space formed by the first housing 310 (i.e., the speaker module 300). The internal space 10 corresponds to a space formed by the outer cover 210 (i.e., the temple frame 200). That is, the first sound may move or resonate not only within the space formed by the speaker module 300, but also move or resonate within the space formed by the temple frame 200.

Referring to FIG. 8, the second sound generated by the speaker module 300 may move or resonate within the second accommodation space 321, and may be discharged to the outside through the second sound hole 212, as described in FIGS. 4 to 6. More specifically, the second sound generated from the front surface 332 of the diaphragm 330 may move or resonate within the second accommodation space 321, and may be discharged to the outside through the second sound hole 212, as described in FIGS. 4 to 6.

The second accommodation space 321 may correspond to the space formed by the second housing 320 (i.e., the speaker module 300). That is, the second sound moves or resonates only within the space formed by the speaker module 300, and cannot move or resonate within the space formed by the temple frame 200 like the first sound.

As illustrated in FIGS. 7 and 8, the first sound may resonate not only within the speaker module 300 but also within the space formed by the temple frame 200, and the second sound may resonate only within the space formed by the speaker module 300. Therefore, the first resonance space in which the first sound resonates may be formed larger than the second resonance space in which the second sound resonates.

That is, the first sound generated from the rear surface 331 of the diaphragm 330 may resonate in a larger space than the second sound generated from the front surface 332 of the diaphragm 330. Accordingly, the first sound generated from the rear surface 331 of the diaphragm 330 also resonates in the internal space 10 of the temple frame 200, so that the first sound emitted through the first sound hole 211 can be canceled out.

That is, the speaker module 300 of the Smart glasses 1000 according to the embodiments may directly discharge the second sound generated from the front surface 332 of the diaphragm 330 to the outside, and may cause the first sound generated from the rear surface 331 of the diaphragm 330 to move sufficiently or resonate and then discharge to the outside without directly discharging the first sound to the outside.

Therefore, the Smart glasses 1000 according to the embodiments may have the effect of accurately providing only the sound required by the user.

As is apparent from the above description, the embodiments of the present disclosure may provide Smart glasses including the speaker module designed to separate resonance spaces of first sound and second sound from each other, thereby efficiently providing sound to the user.

The above detailed description is to be construed in all aspects as illustrative and not restrictive. The scope of the present disclosure should be determined by reasonable interpretation of the appended claims and all changes coming within the equivalency range of the present disclosure are intended to be embraced in the scope of the present disclosure.

It will be apparent to those skilled in the art that various modifications and variations can be made in the present disclosure without departing from the spirit or scope of the disclosure. Thus, it is intended that the present disclosure covers the modifications and variations of this disclosure provided they come within the scope of the appended claims and their equivalents.

What is claimed is:

1. A Smart glasses comprising:
a lens frame configured to support a pair of lenses; and
a pair of temple frames configured to be hinge-coupled to the lens frame,
wherein the temple frames include:
an outer cover configured to form an inner space;
an inner cover coupled to the outer cover and including a contact portion that contacts a user's skin; and
a speaker device disposed in the inner space,
wherein the speaker device includes:
a first housing forming a first accommodation space connected to the inner space;
a second housing accommodated in the first housing and forming a second accommodation space; and
a diaphragm disposed at one surface of the second housing,
wherein
the first accommodation space and the inner space form a first resonance space in which a first sound generated by vibration of the diaphragm resonates; and
the second accommodation space forms a second resonance space in which a second sound generated by vibration of the diaphragm resonates.

2. The Smart glasses according to claim 1, wherein the outer cover includes:
a first sound hole formed at an upper portion of the outer cover; and
a second sound hole formed at a lower portion of the outer cover,
wherein
the first sound is emitted to the outside through the first sound hole; and
the second sound is emitted to the outside through the second sound hole.

3. The Smart glasses according to claim 2, wherein:
a movement path of the first sound to the first sound hole is longer than a movement path of the second sound to the second sound hole.

4. The Smart glasses according to claim 2, wherein the outer cover includes:
a prevention member configured to prevent moisture from entering the temple frame through the first sound hole or the second sound hole.

5. The Smart glasses according to claim 1, wherein:
the diaphragm is arranged such that a rear surface of the diaphragm is located in the first accommodation space and a front surface of the diaphragm is located in the second accommodation space.

6. The Smart glasses according to claim 5, wherein:
the first accommodation space is formed by the rear surface of the diaphragm; and
the second accommodation space is formed by the front surface of the diaphragm.

7. The Smart glasses according to claim 6, wherein the diaphragm includes:
a convex portion formed convexly from the front surface of the diaphragm.

8. The Smart glasses according to claim 1, wherein:
the first sound corresponds to a sound generated from the rear surface of the diaphragm; and
the second sound corresponds to a sound generated from the front surface of the diaphragm.

9. The Smart glasses according to claim 1, wherein:
the first resonance space is formed to have a larger size than the second resonance space.

10. The Smart glasses according to claim 1, wherein:
the first resonance space is acoustically separated from the second resonance space.

11. The Smart glasses according to claim 1, wherein:
the first accommodation space is formed separately from the second accommodation space.

12. The Smart glasses according to claim 1, wherein:
the first housing includes a through-hole formed on one surface; and
the first sound moves from the first accommodation space to the internal space through the through-hole.
